(19) United States
(12) Patent Application Publication
(10) Pub. No.: US 2007/0096627 A1
(43) Pub. Date: May 3, 2007

(54) Electron emission device and electron emission display device using the same

(76) Inventors: Ki-Hyun Noh, Yongin-si (KR); Chun-Gyoo Lee, Yongin-si (KR); Sang-Jo Lee, Yongin-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/586,931

(22) Filed: Oct. 26, 2006

(30) Foreign Application Priority Data
Oct. 31, 2005 (KR) 10-2005-0103315
Oct. 31, 2005 (KR) 10-2005-0103531

(51) Int. Cl. H01J 63/04; H01J 1/62

(52) U.S. Cl. 313/496

(57) ABSTRACT

An electron emission device is disclosed. The electron emission device includes a cathode electrode including i) a first electrode, ii) a plurality of second electrodes, iii) at least one resistance layer adapted to electrically connect the first electrode and the plurality of second electrodes, and iv) a plurality of sub-electrodes. The plurality of sub-electrodes are adapted to electrically connect each other. At least one of the plurality of sub-electrodes contacts the resistance layer.

### CROSS-REFERENCES TO RELATED APPLICATIONS

This application claims priority to Korean patent application Nos. 10-2005-0103315 and 10-2005-0103531 filed in the Korean Intellectual Property Office on Oct. 31, 2005, and all the benefits accruing therefrom under 35 U.S.C.§119, the contents of which are herein incorporated by reference in their entirety.

### BACKGROUND OF THE INVENTION

1. Field of the invention

The present embodiments relate to an electron emission device and an electron emission display device using the same.

2. Description of the Related Technology

A hot or cold cathode can be used as an electron emission source in an electron emission device. There are several types of cold cathode electron emission devices, such as a field emitter array (FEA) electron emission device, a surface conduction emission (SCE) electron emission device, a metal-insulator-metal (MIM) electron emission device, a metal-insulator-semiconductor (MIS) electron emission device, etc.

Among these electron emission devices, the FEA electron emission device is provided with cathode and gate electrodes as driving electrodes for controlling electron emission units and emission of electrons thereof. Materials having a low work function or a high aspect ratio are used for constituting an electron emission unit in the FEA electron emission device. For example, carbon-based materials such as carbon nanotubes, graphite, and diamond-like carbon have been developed to be used in an electron emission unit in order for electrons to be easily emitted by an electrical field in a vacuum.

The plurality of electron emission units are arrayed on a substrate to form an electron emission device, and the electron emission device is combined with another substrate on which phosphors and anode electrodes are formed to produce an electron emission display device.

### SUMMARY OF CERTAIN INVENTIVE ASPECTS

One aspect of the present embodiments provides an electron emission device including i) a substrate, ii) a cathode electrode located on the substrate, iii) a gate electrode electrically insulated from the cathode electrode, and iv) a plurality of electron emission units adapted to electrically connect the cathode electrode. The cathode electrode includes i) a first electrode, ii) a plurality of second electrodes, iii) at least one resistance layer adapted to electrically connect the first electrode and the plurality of second electrodes, and iv) a plurality of sub-electrodes adapted to electrically connect with each other. At least one of the plurality of sub-electrodes contacts the resistance layer.

At least two of the sub-electrodes may directly contact each other. The resistance layer may include a plurality of surfaces, and at least two of the sub-electrodes contact the different surfaces of the resistance layer. The first electrode and the plurality of second electrodes may be spaced apart from each other. The first electrode may have a plurality of openings, and the plurality of second electrodes may be located within at least one of the plurality of openings.

The plurality of sub-electrodes may include i) a first sub-electrode located on the first electrode, and ii) at least one second sub-electrode located on the resistance layer. At least one of the plurality of electron emission units may be located on at least one of the plurality of second electrodes, and the first sub-electrode may cover the plurality of second electrodes except an area where at least one of the plurality of electron emission units is located. The first sub-electrode may include at least one of chrome (Cr) and molybdenum (Mo). The second sub-electrode may include at least one of aluminum (Al) and silver (Ag).

At least one resistance layer may include a pair of resistance layers extending in a longitudinal direction of the cathode electrode, and each resistance layer may be located on both sides of each of the plurality of second electrodes. The second sub-electrode may include a pair of line portions extending in a longitudinal direction of the resistance layer and spaced apart from each other. The second sub-electrode may further include a connecting portion located between the plurality of openings, connecting the pair of line portions, and contacting the first sub-electrode. The resistance layer may have a plurality of via holes, and the first and second sub-electrodes may contact each other through at least one of the plurality of via holes. At least one of the plurality of via holes may be formed between the plurality of openings. At least one of the plurality of via holes may be formed between an edge of the cathode electrode and one of the plurality of openings closest to the edge. The edge may extend in a direction to cross the longitudinal direction of the cathode electrode.

The resistances of the plurality of sub-electrodes may be different from each other. The resistance of the second sub-electrode may be lower than the resistance of the first sub-electrode. The resistance of each of the plurality of sub-electrodes may be lower than the resistance of the first electrode. At least one of the plurality of sub-electrodes may be made of an opaque material.

At least one second sub-electrode may include a pair of second sub-electrodes, and the pair of second sub-electrodes may be spaced apart from each other. At least one sub-electrode among the plurality of sub-electrodes may be located on the first electrode.

Another aspect of the present embodiments provides an electron emission display device including i) first and second substrates opposing each other, ii) a cathode electrode located on the first substrate, iii) a gate electrode electrically insulated from the cathode electrode, iv) a plurality of electron emission units adapted to electrically connect the cathode electrode, v) a phosphor layer located on the second substrate, and vi) an anode electrode located on the second substrate. The cathode electrode includes i) a first electrode, ii) a plurality of second electrodes, iii) at least one resistance layer adapted to electrically connect the first electrode and the plurality of second electrodes, and iv) a plurality of sub-electrodes adapted to electrically connect to each other. At least one of the sub-electrodes contacts the resistance layer.

### BRIEF DESCRIPTION OF THE DRAWINGS

FIG. 1 is a partial exploded perspective view of the electron emission display device in accordance with an embodiment.

FIG. 2 is a cross-sectional view of the electron emission display device taken along the line II-II of FIG. 1.

FIG. 3 is a partial plan view of the cathode electrode in accordance with an embodiment.

FIG. 4 is a partial plan view of the cathode electrode in accordance with another embodiment.

FIG. 5 is a cross-sectional view of the cathode electrode taken along the line V-V of FIG. 4.

FIG. 6 is a partial plan view of the cathode electrode in accordance with another embodiment.

FIG. 7 is a partial plan view of the cathode electrode in accordance with another embodiment.

### DETAILED DESCRIPTION OF CERTAIN INVENTIVE EMBODIMENTS

With reference to the accompanying drawings, embodiments will be described in order for those skilled in the art to be able to implement it. As those skilled in the art would realize, the described embodiments may be modified in various different ways, all without departing from the spirit or scope of the present embodiments. Wherever possible, the same reference numbers will be used throughout the drawings to refer to the same or like parts.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms first, second, third, etc., may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of the present embodiments.

The terminology used herein is for the purpose of describing particular embodiments only and is not intended to be limiting of the embodiments. As used herein, the singular forms “a”, “an”, and “the” are intended to include the plural forms as well, unless the context clearly indicates otherwise. It will be further understood that the terms “comprises” and/or “comprising,” or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “below”, “lower”, “above”, “upper”, “over”, and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein are interpreted accordingly.

Unless otherwise defined, all terms (including technical and scientific terms) used herein have the same meaning as commonly understood by one of ordinary skill in the relevant art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross-sectional illustrations that are schematic illustrations of preferred embodiments. As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing. As an example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present embodiments.

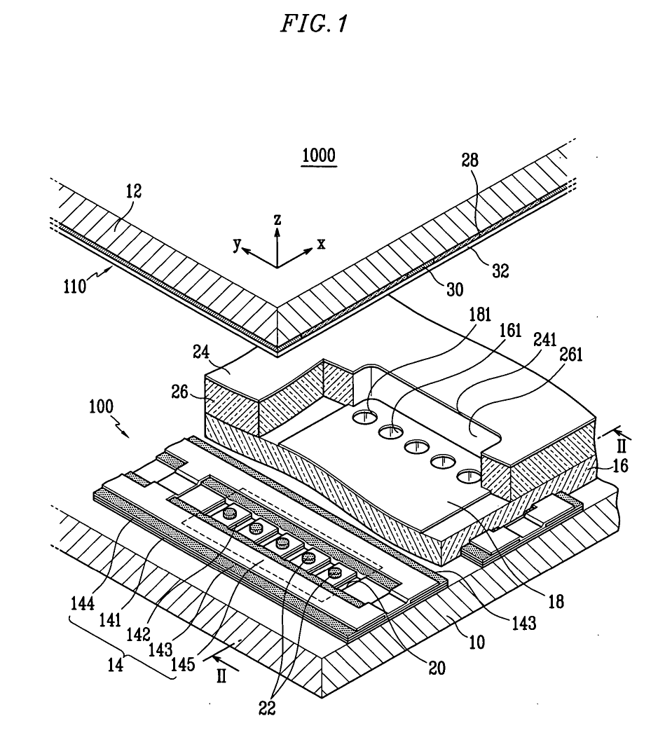

FIG. 1 illustrates a partial exploded perspective view of the electron emission display device 1000 in accordance with an embodiment.

As illustrated in FIG. 1, the electron emission display device 1000 includes first and second substrates 10 and 12 facing each other. The first and second substrates 10 and 12 are located to be parallel to each other with a predetermined distance therebetween. A sealing member (not shown) is located on edges of the first and second substrates 10 and 12 such that they are attached to each other. The internal space surrounded by the two substrates 10 and 12 and the sealing member is evacuated to approximately 10⁻⁶ torr to form a vacuum vessel.

Electron emission units 22 are arranged to be an array on the first substrate 10 facing the second substrate 12, and they constitute an electron emission device 100 together with the first substrate 10. The electron emission device 100 is assembled with the second substrate 12 and a light emitting unit 110 provided on the second substrate 12, thereby constituting an electron emission display device 1000.

Cathode electrodes 14 are formed in a stripe pattern on the first substrate 10, and a first insulating layer 16 is located on the entire surface of the first substrate 10 while covering the cathode electrodes 14. Cathode electrodes 14 extend in the y-axis direction. Gate electrodes 18 are also located on the first insulating layer 16 to be electrically insulated from the cathode electrodes 14 in a stripe pattern, and extend in a direction to cross the cathode electrodes 14 (x-axis direction).

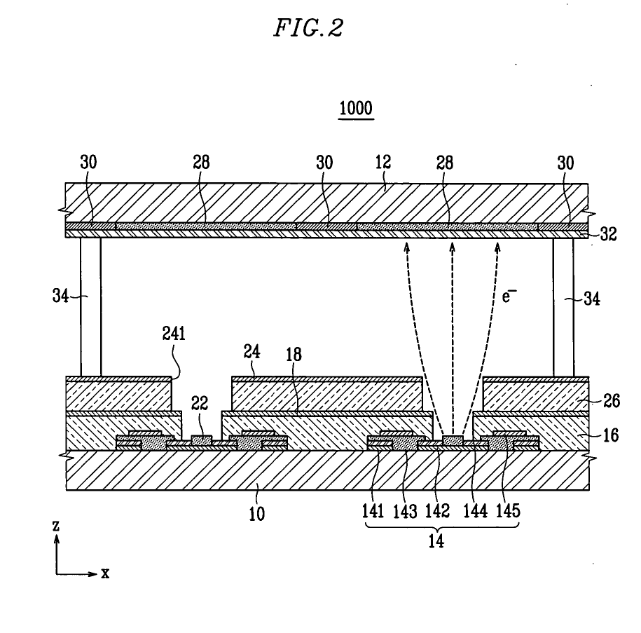

In one embodiment, a unit pixel is formed at a crossing area of the cathode electrode 14 and the gate electrode 18. The cathode electrode 14 includes a main electrode 141, a plurality of isolated electrodes 142, a resistance layer 143, and sub-electrodes 144 and 145 in the unit pixel. As illustrated in FIG. 2, if a left edge portion of the cathode electrode 14 is seen, the resistance layer 143 is located on the first sub-electrode 144, and the first sub-electrode 144 is located on the first electrode 141. In addition, the second sub-electrode 145 is located on the resistance layer 143. The main electrode 141 is located on the isolated electrode 142 within an opening 20.

The opening 20 (dotted line in FIG. 1) is formed in the main electrode 141. The main electrode 141 has a plurality of openings 20 arranged in the y-axis direction. The plurality of isolated electrodes 142 are located within the opening 20.

The main electrode 141 and the plurality of isolated electrodes 142 are spaced apart from each other. The main electrode 141 is adapted to electrically connect the plurality of isolated electrodes 142 through a pair of resistance layers 143 at left and right sides of the isolated electrodes 142. The resistance layers 143 extend in the y-axis direction, and partially cover the opening 20, the main electrode 141, and the isolated electrodes 142. As a result, contact resistance between the main electrode 141 and the isolated electrodes 142 is reduced. One end of the main electrode 141 is configured to electrically connect an external circuit (not shown), and a driving voltage is applied to the main electrode 141 through the external circuit.

The resistance layer 143 is made of a material with a specific resistance in the range from about 10,000 Ωcm to about 100,000 Ωcm. The specific resistance of the material is greater than that of a general conductive material contained in the main electrode 141 and the isolated electrodes 142. The material may include, for example, p-type doped amorphous silicon.

In one embodiment, even if an unstable driving voltage is applied to the main electrode 141 or if the voltage is suddenly dropped in the main electrode 141, a stable driving voltage can be continuously applied to the electron emission unit 22 due to the resistance layer 143. Therefore, electron emission properties of the electron emission unit 22 can be uniformly maintained.

The electron emission unit 22 is located on the isolated electrode 142. The electron emission unit 22 contains materials that are capable of emitting electrons, such as carbon-based or nanometer-sized materials, when an electric field is formed. The electron emitting unit 22 may contain, for example, carbon nanotubes, graphite, graphite nanofibers, diamond, diamond-like carbon, C₆₀, silicon nanowire, or combinations thereof. The electron emission unit 22 may have a sharp tip and be mainly made of, for example, molybdenum, silicon, and so on. The openings 161 and 181 are formed in the first insulating layer 16 and the gate electrodes 18, respectively, in order for the electron emission unit 22 to maintain a space for emitting electrons.

A focusing electrode 24 is located on a second insulating layer 26. Therefore, the gate electrode 18 is insulated from the focusing electrode 24. Openings 261 and 241 are provided in the second insulating layer 26 and the focusing electrode 24, respectively, so that electron beams emitted from the electron emission unit 20 pass through the openings 261 and 241. One set of the openings 261 and 241 may be formed on the unit pixel. As a result, electrons emitted from the unit pixel are focused well.

In one embodiment, referring to FIG. 2, the first and second sub-electrodes 144 and 145 reduce the resistance of the main electrode 141. The resistance of the main electrode 141 may be relatively high due to the opening 20 and its internal resistance. The valid width, that is, the width of the electrode that substantially contributes a current flow in the unit pixel, of the main electrode 141 is decreased due to the opening 20. Therefore, the resistance of the main electrode 141 with the opening 20 is greater than that without the opening.

The main and isolated electrodes 141 and 142 may be made of a transparent conductive material such as indium tin oxide (ITO) whose resistance is relatively high. The main and isolated electrodes 141 and 142 are made of transparent conductive material because ultraviolet rays from outside of the first substrate 10 should transmit to the main and isolated electrodes 141 and 142 in order to harden the electron emission units 20 during a backside exposure process.

In one embodiment, since first and second sub-electrodes 144 and 145 reduce the resistance of the main electrode 141, uniform voltages can be applied to each of the electron emission units 22. Therefore, there is little difference in voltages applied to the electron emission units 22. As a result, electron emission characteristics of the electron emission units 22 are substantially equalized and then display quality is enhanced due to a uniform electron emission of the electron emission units 22.

In a conventional electron emission display device, resistance of the cathode electrode is relatively high and is not reduced even if the resistance layer is used. In addition, even with the resistance layer, it is difficult to equalize electron emission characteristics of the electron emission units. Therefore, voltages applied to the electron emission units are gradually decreased in a longitudinal direction of the cathode electrode because the applied voltages are dropped in the cathode electrode. As a result, electron emission uniformity is reduced and then display quality is deteriorated.

In one embodiment, the resistances of the first and second sub-electrodes 144 and 145 are lower than that of the main electrode 141. The first and second sub-electrodes 144 and 145 electrically contact the main electrode 141. Therefore, the resistance of the cathode electrode 14 is totally reduced due to the first and second sub-electrodes 144 and 145.

The first sub-electrode 144 may include at least one of chromium (Cr) and molybdenum (Mo). The resistances of chromium (Cr) and molybdenum (Mo) are lower than that of ITO. A material contained in the first sub-electrode 144 may satisfy a condition that a galvanic reaction is not generated between the first sub-electrode 144 and at least one of the main electrode 141, the isolated electrode 142, or the resistance layer 143 during its manufacturing process. In addition, it may not be harmed in liquid solutions for etching the ITO and the resistance layer 143. The chrome and molybdenum may satisfy these conditions.

The second sub-electrode 145 may include highly conductive metallic materials, for example, at least one of aluminum (Al) and silver (Ag). The materials may be metals that satisfy a condition that a liquid solution for etching the second sub-electrode 145 does not influence the main electrode 141, and the isolated electrodes 142, the resistance layer 143, and the first sub-electrode 144.

The resistances of the first and second sub-electrodes 144 and 145 may be different from each other. For example, the resistance of the second sub-electrode 145 may be lower than that of the first sub-electrode 144 if the second sub-electrode 145 contains aluminum or silver.

The main electrode 141 and isolated electrode 142 may be made of transparent materials such as ITO, while the first and second sub-electrodes 144 and 145 may be made of opaque metallic materials. Since the first and second sub-electrodes 144 and 145 may be formed after forming the electron emission units 22 on the isolated electrodes 142 by using the backside exposure process, they may be made of opaque materials.

In one embodiment, phosphor layers 28 are formed to be spaced apart from each other on a surface of the second substrate 12 facing the first substrate 10. The phosphors layers 28 may include red (R), green (G), and blue (B) phosphor layers. Black layers 30 are formed between each of the phosphor layers 28 in order to absorb ambient light. Each phosphor layer 28 corresponds to the unit pixel.

In addition, anode electrodes 32 made of a metallic film such as aluminum are formed on the phosphor layers 28 and the black layers 30. External high voltages, which are sufficient to accelerate electron beams, are applied to the anode electrodes 32 and are then maintained at high electric potentials by the anode electrodes 32. Among the visible rays emitted from the phosphor layers 28, visible rays directed to the first substrate 10 are reflected toward the second substrate 12 by the anode electrodes 32, and thereby brightness is enhanced.

In another embodiment, the anode electrodes 32 can be made of a transparent conductive layer such as ITO. In this case, the anode electrode may be located between the second substrate and the phosphor layers. Alternatively, the transparent conductive layer and a metallic layer can be formed together as an anode electrode.

FIG. 2 illustrates is a cross-sectional view of the electron emission display device 1000 taken along the line II-II of FIG. 1.

Spacers 34 are located between the two substrates 10 and 12, thereby supporting the substrates 10 and 12 against a compressing force applied to a vacuum space therebetween. The spacers 34 uniformly maintain a gap between the two substrates 10 and 12, and they are located directly beneath the black layers 30 in order for them to be invisible from the outside.

In one embodiment, the electron emission display device 1000 is driven by external voltages to be applied to the cathode electrode 14, the gate electrode 18, the focusing electrode 24, and the anode electrode 32. Scan driving voltages are applied to one of the cathode electrode 14 and the gate electrode 18, and thus the one electrode functions as a scanning electrode. In addition, data driving voltages are applied to the other electrode, and thus the other electrode functions as a data electrode. Voltages necessary to focus the electron beams, such as 0V or negative direct current voltages of several to several tens of volts, are applied to the focusing electrode 24, while positive direct current voltages of several hundreds to several thousands of volts are applied to the anode electrode 32 for accelerating electron beams.

Then, electric fields are formed around the electron emission unit 22 at the unit pixels where the voltage difference between the cathode electrode 14 and the gate electrode 18 exceeds a threshold value, and thereby electrons emit therefrom. The emitted electrons are focused on a center portion of the electron beams while passing through the opening 241 of the focusing electrodes 24. They are also attracted by the high voltage applied to the anode electrode 32 and collide against the corresponding phosphor layers 28. Thus, light is emitted from the electron emission display device 1000 and an image is displayed.

As illustrated in FIG. 2, the first sub-electrode 144 is located on the main electrode 141 while the second sub-electrode 145 is located on the resistance layer 143. The first sub-electrode 144 covers the second electrodes 142. The first sub-electrode 144 does not cover an area where the electron emission unit 22 is located on the main electrode 141.

The resistance layer 143 contacts the first and second sub-electrodes 144 and 145. The resistance layer 143 includes a plurality of surfaces. The first sub-electrode 144 contacts a side surface of the resistance layer 143 while the second sub-electrode 145 contacts an upper surface of the resistance layer 143. The first and second sub-electrodes 144 and 145 contact different surfaces of the resistance layer 143. The first and second sub-electrodes 144 and 145 may electrically connect to each other through the resistance layer 143.

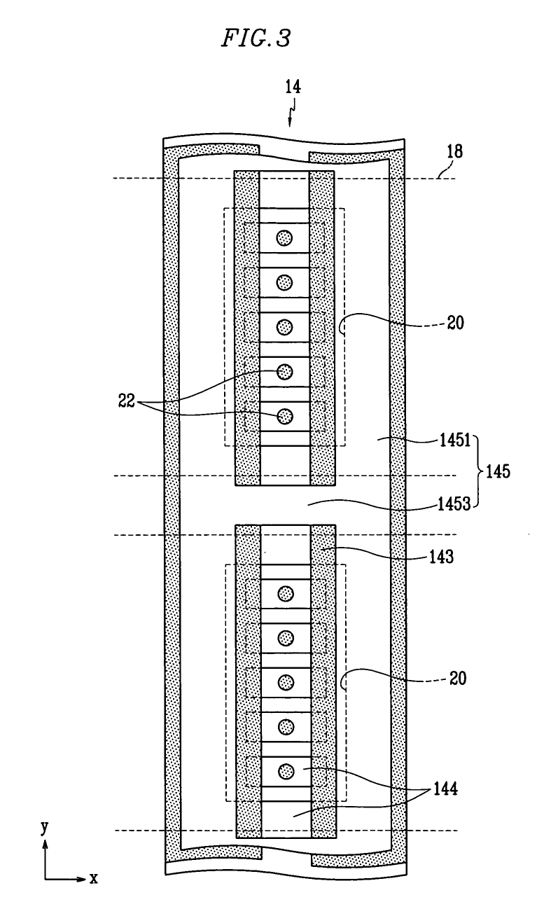

FIG. 3 illustrates a partial plan view of the cathode electrode 14 in accordance with an embodiment. Dotted lines in FIG. 3 indicate gate electrodes 18 that are arranged in a direction to cross the cathode electrodes 14.

As illustrated in FIG. 3, the second sub-electrode 145 is located on the resistance layer 143. The second sub-electrode 145 includes a pair of line portions 1451 and a connecting portion 1453. The pair of line portions 1451 extend in the y-axis direction and are spaced apart from each other. The connecting portion 1453 connects the pair of line portions 1451, and contacts the first sub-electrode 144 at an area between the openings 20. The connecting portion 1453 contacts the first sub-electrode 144, and is adapted to electrically connect the first sub-electrode 144. Since the second sub-electrode 145, whose electric conductivity is higher than that of the first sub-electrode 144 contacts the first sub-electrode 144 at an area between the unit pixels, the first and second sub-electrodes 144 and 145 can effectively reduce a resistance of the main electrode 141. As a result, uniform voltages are applied to the electron emission units and electron emission uniformity thereof is improved. Therefore, display quality of the electron emission display device is enhanced.

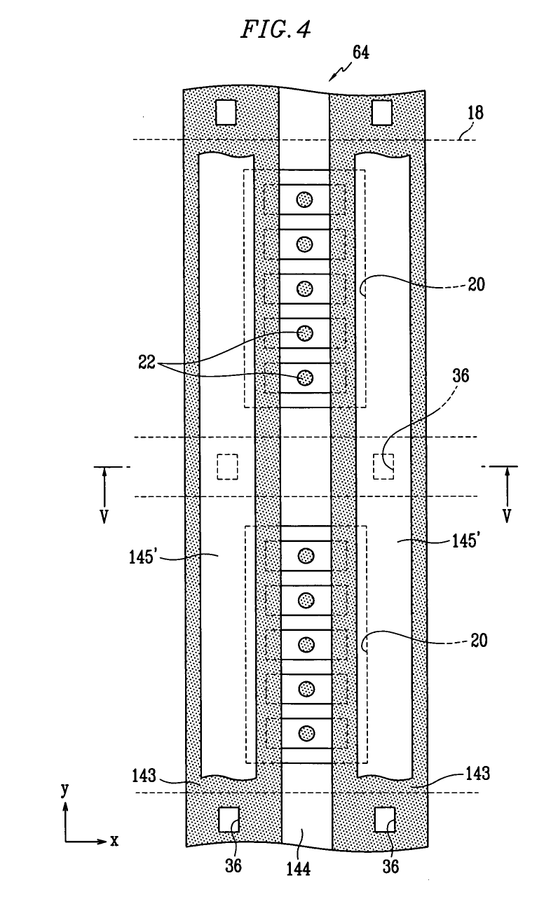

FIG. 4 illustrates a partial plan view of the cathode electrode 64 in accordance with another embodiment. Since the cathode electrode 64 is similar to the cathode electrode 14 illustrated in FIG. 3, like reference numerals refer to like elements and detailed explanation thereof is omitted for convenience.

As illustrated in FIG. 4, the second sub-electrodes 145′ extend in the y-axis direction. The second sub-electrodes 145′ are formed to be a stripe pattern along a longitudinal direction of the resistance layer 143. Via holes 36 are formed in the resistance layer 143. The via holes 36 are formed at the area between the openings 20. The via holes 36 are formed at an area between the unit pixels that has a sufficient space for patterning. A plurality of via holes 36 are formed along a longitudinal direction of the resistance layer 143.

Although not illustrated in FIG. 4, the via hole may be also formed at an area between an opening and an edge of the cathode electrode 64. The opening is closest to the edge extending in the x-axis direction. That is, an extending direction of the edge crosses the longitudinal direction of the cathode electrode 64.

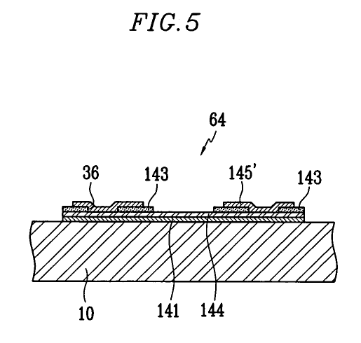

FIG. 5 illustrates a cross-sectional view of the cathode electrode 64 taken along the line V-V of FIG. 4.

As illustrated in FIG. 5, the first sub-electrode 144 contacts the second sub-electrode 145′ and is adapted to electrically connect the second sub-electrode 145′. Therefore, a resistance of the main electrode 141 can be effectively reduced by the first and second sub-electrodes 144 and 145′.

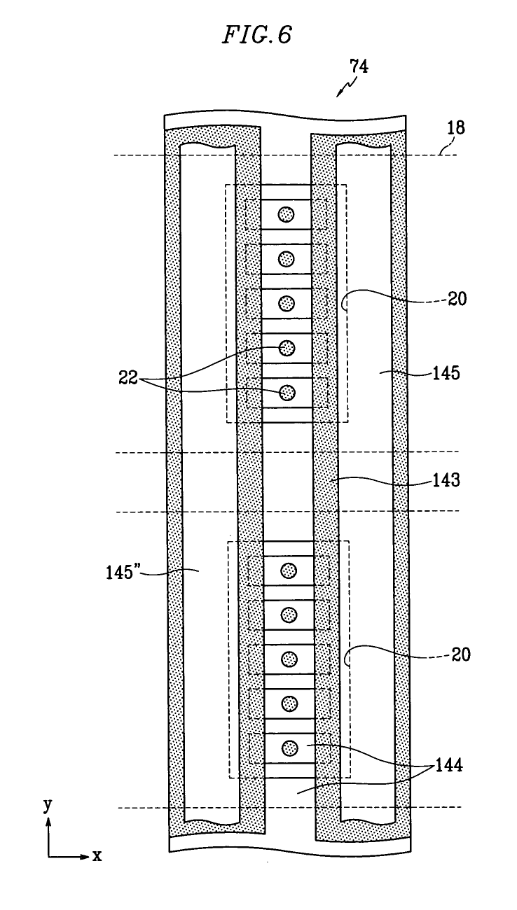

FIG. 6 illustrates a partial plan view of the cathode electrode 74 in accordance with another embodiment. Since the cathode electrode 74 is similar to the cathode electrode 14 illustrated in FIG. 3, like reference numerals refer to like elements and detailed explanation thereof is omitted for convenience.

As illustrated in FIG. 6, a pair of the second sub-electrodes 145″ are spaced apart from each other and located on the resistance layer 143. The couple of the second sub-electrodes 145″ are formed in a stripe pattern along a longitudinal direction of the resistance layer 143.

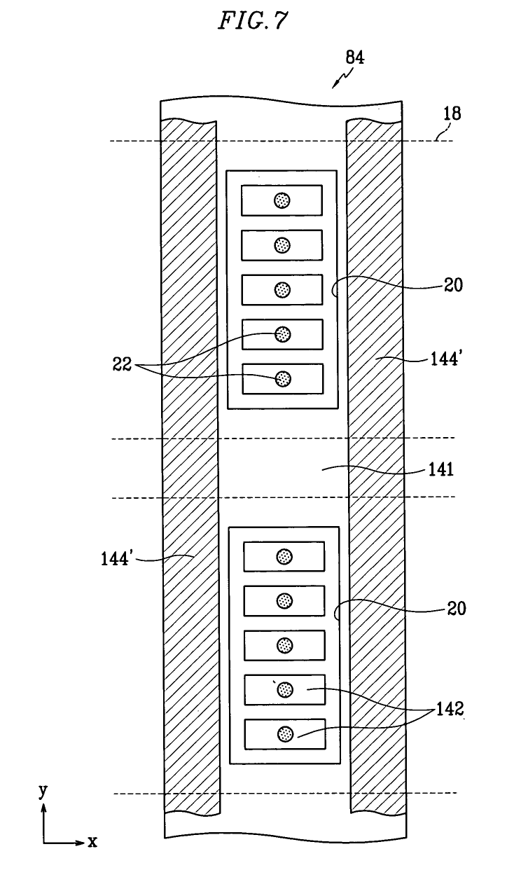

FIG. 7 illustrates a partial plan view of the cathode electrode 84 in accordance with another embodiment. Since the cathode electrode 84 is similar to the cathode electrode 14 illustrated in FIG. 3, like reference numerals refer to like elements and detailed explanation thereof is omitted for convenience. In addition, a resistance layer, which comes in contact with the first sub-electrode 144′, is omitted for convenience.

As illustrated in FIG. 7, the first sub-electrode 144′ is located on the main electrode 141. The first sub-electrode 144′ is formed in a stripe pattern along a longitudinal direction of the main electrode 141.

While the above description has pointed out novel features applied to various embodiments, the skilled person will understand that various omissions, substitutions, and changes in the form and details of the device or process illustrated may be made without departing from the scope of the embodiments. Therefore, the scope of the embodiments is defined by the appended claims rather than by the foregoing description. All variations coming within the meaning and range of equivalency of the claims are embraced within their scope.

What is claimed is:

1. An electron emission device, comprising:
a substrate;
a cathode electrode located on the substrate;
a gate electrode electrically insulated from the cathode electrode; and
a plurality of electron emission units configured to electrically connect to the cathode electrode,
wherein the cathode electrode comprises
a first electrode,
a plurality of second electrodes,
at least one resistance layer configured to electrically connect the first electrode and the plurality of second electrodes, and
a plurality of sub-electrodes configured to electrically connect to each other wherein at least one of the sub-electrodes contacts the resistance layer.

2. The device of claim 1, wherein at least two of the plurality of sub-electrodes directly contact each other.

3. The device of claim 1, wherein the resistance layer comprises a plurality of surfaces, and
wherein at least two of the sub-electrodes contact different surfaces of the resistance layer.

4. The device of claim 1, wherein the first electrode and the plurality of second electrodes are spaced apart from each other.

5. The device of claim 4, wherein the first electrode has a plurality of openings, and
wherein the plurality of second electrodes are located within at least one of the plurality of openings.

6. The device of claim 5, wherein the plurality of sub-electrodes comprise:
a first sub-electrode located on the first electrode; and
at least one second sub-electrode located on the resistance layer.

7. The device of claim 6, wherein at least one of the plurality of electron emission units is located on at least one of the plurality of the second electrodes, and wherein the first sub-electrode covers the plurality of second electrodes except an area where at least one of the plurality of electron emission units is located.

8. The device of claim 6, wherein the first sub-electrode comprises at least one of chromium (Cr) and molybdenum (Mo).

9. The device of claim 6, wherein the second sub-electrode comprises at least one of aluminum (Al) and silver (Ag).

10. The device of claim 6, wherein at least one resistance layer comprises a pair of resistance layers extending in a longitudinal direction of the cathode electrode, and each resistance layer is located on both sides of each of the plurality of second electrodes.

11. The device of claim 6, wherein the second sub-electrode comprises a pair of line portions extending in a longitudinal direction of the resistance layer and spaced apart from each other.

12. The device of claim 11, wherein the second sub-electrode further comprises a connecting portion located between the plurality of openings, connecting the pair of line portions, and contacting the first sub-electrode.

13. The device of claim 11, wherein the resistance layer has a plurality of via holes, and
wherein the first and second sub-electrodes contact each other through at least one of the plurality of via holes.

14. The device of claim 13, wherein at least one of the plurality of via holes is formed between the plurality of openings.

15. The device of claim 13, wherein at least one of the plurality of via holes is formed between an edge of the cathode electrode and one of the plurality of openings closest to the edge, the edge extending in a direction to cross the longitudinal direction of the cathode electrode.

16. The device of claim 6, wherein the resistances of the plurality of sub-electrodes are different from each other.

17. The device of claim 16, wherein the resistance of the second sub-electrode is lower than the resistance of the first sub-electrode.

18. The device of claim 6, wherein the at least one second sub-electrode comprises a pair of second sub-electrodes, and the pair of second sub-electrodes are spaced apart from each other.

19. The device of claim 1, wherein at least one sub-electrode among the plurality of sub-electrodes is located on the first electrode.

20. The device of claim 1, wherein the resistance of each of the plurality of sub-electrodes is lower than the resistance of the first electrode.

21. The device of claim 1, wherein at least one of the plurality of sub-electrodes is made of an opaque material.

22. An electron emission display device comprising:
first and second substrates opposed to each other;
a cathode electrode located on the first substrate;
a gate electrode electrically insulated from the cathode electrode;
a plurality of electron emission units adapted to electrically connect the cathode electrode;
a phosphor layer located on the second substrate; and
an anode electrode located on the second substrate,
wherein the cathode electrode comprises
a first electrode,
a plurality of second electrodes,
at least one resistance layer configured to electrically connect to the first electrode and the plurality of second electrodes, and
a plurality of sub-electrodes configured to electrically connect to each other wherein at least one of the sub-electrodes contacts the resistance layer.
